(19) United States
(12) Patent Application Publication
(10) Pub. No.: US 2001/0041116 A1
(43) Pub. Date: Nov. 15, 2001

(54) Method for moving a round hay bale

(76) Inventor: Emmanuel P. Noualy, Vulcan (CA)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/909,327

(22) Filed: Jul. 18, 2001

Related U.S. Application Data
(63) Continuation-in-part of application No. 09/488,968, filed on Jan. 21, 2000.

(51) Int. Cl. A01D 85/00

(52) U.S. Cl. 414/24.5; 414/399

(57) ABSTRACT

A method for moving a round hay bale comprises: positioning the bale onto its circular peripheral surface; approaching a proximal flat side of the bale; positioning a main bale impaling spike in a horizontal attitude as supported by a vertical bale support assembly of a tow frame; adjusting a vertical position of the main bale impaling spike at a height above a center of mass of the bale; positioning a pair of lateral bale impaling spikes in parallel with the main bale impaling spike and at a height below the center of mass of the bale; driving the spikes into the bale so as to position the main bale impaling spike above the bale center of mass and to position the pair of lateral bale impaling spikes below and to each side of the bale center of mass; pulling the bale support assembly into a tilted attitude about a rotational axis to lift the bale off the ground; locking the bale support assembly with the bale center of mass positioned to urge the bale support assembly into the vertical; transporting the bale on the tow frame; releasing the bale support assembly to position the bale on the ground; and withdrawing the main and lateral spikes from engagement with the bale.

This application is a Continuation In Part of 09/488,968 filed on Jan. 21, 2000, which, in turn, claims the date of a Provisional Patent Application, having Ser. No. 60/117,843 and filing date of Feb. 1, 1999.

### BACKGROUND OF THE INVENTION

1. Field of The Invention

This invention relates generally to farm equipment drawn by a separate vehicle, and more particularly to a method of using a trailer for lifting, moving, handling, and unrolling bales of feed or bedding, especially those with a round outer surface.

2. Description of Related Arts

The following art defines the present state of this field:

Hedgespeth, U.S. Pat. No. 4,348,148 describes a large round hay bale trailer having a fork lift cradle pivotally mounted on a two wheel trailer frame, the cradle being formed by pipe having a 90 degree vertical and horizontal bends to provide fork, back support and horizontal connecting elements. Laterally extending pipe sections welded to the cradle pipe provide pivotal bearings for a horizontal wheel axle pipe to which trailer frame elements are also secured.

Smith, U.S. Pat. No. 5,178,505 describes an attachment for the three-point hitch of a farm tractor including a generally vertically disposed, inverted U-shaped frame having outwardly extending lower ends connected to a pair of lower lift arms forming part of the three-point hitch of the tractor. The top portion of the frame is pivotally and longitudinally adjustably connected to a telescopically adjustable stabilizer link or bar having its forward end pivotally connected to the usual attachment point of the stabilizer link of a three-point hitch assembly provided on a farm tractor. The outer end of the stabilizer bar includes a transverse sleeve by which various devices including a round hay bale moving device can be pivotally attached. The upper surface of the longitudinally movable component of the telescopic stabilizer bar is provided with a rigid lug to which a hydraulic ram can be pivotally connected with the other end of the hydraulic ram being connected pivotally to the hay moving device or other device attached to the outer end of the stabilizer bar.

Clay, Sr., U.S. Pat. No. 5,603,597 describes a one man round hay bale lifter and transport device for quick assembly and disassembly to a conventional trailer hitch mounted on a pick-up truck. The lifting and transport device includes an anchoring structure and a hay bale lifting and holding structure pivotally mounted on the anchoring structure. The rearward end of the anchoring structure includes a square tube for quick assembly with the square tube of the conventional trailer hitch. A ratchet binder is pivotally mounted on the anchoring structure at one end and on the hay bale lifting structure on the other end. By manually rotating the ratchet handle mounted on a threaded sleeve of the ratchet binder, the lifting structure is elevatable to a maximum angle of about 45 degree with respect to the anchoring structure. A stop bar engages an edge of the anchoring structure to limit further elevation or lowering of the lifting structure. The lifting structure includes at its front end a pronged fork assembly for engaging and lifting the hay bale upon elevation of the lifting structure. Once a hay bale is elevated, the truck is driven to transport the hay bale to a desired location where the operation is reversed to drop off the transported hay bale.

Barker, U.S. Pat. No. 5,664,924 describes a new Round Bale Handling System offering a simple inexpensive device for lifting and unrolling round bales. The inventive device includes a frame, a lifting shaft, two tow chains, and a roll shaft. In use, the farm tractor 4 is backed up and the lifting shaft 30 is forced longitudinally axially into a round bale 2. The farm tractor's hitch is then used to lift the round bale 2 and the round bale 2 can be hauled by the farm tractor 4 to any desired location. When the round bale 2 has been placed, the farm tractor 4 is then relocated around and backed up to the round bale 2 so that the farm tractor 4 is normal to a rolling axis of the round bale 2. The roll shaft 50 is then pushed through the round bale 2 along its rolling axis and the tow chain 40 is rotatably attached to the roll shaft 50 by use of the retaining pin 56 and the hair clip pin 58. The farm tractor 4 then pulls the roll shaft 50 and the round bale 2 rotates about the roll shaft 50 and unrolls as it does so.

Bales, U.S. Pat. No. 5,833,424 describes a hand operated hay bale lifter having a size and weight that can be handled by one person and including a square coupling bar that can be quickly and easily inserted into the receiver pocket of a standard tow bar trailer hitch. Mechanical lifting force produced by a hydraulic jack assembly is transferred to a fork assembly through a contact coupling provided by an open bearing cup or socket mounted on the fork assembly. The hydraulic jack assembly includes a hand pump, a hydraulic power cylinder and a piston rod mounted on an outboard support stub. The bearing cup or socket rotates in sliding engagement against the piston rod during extension and retraction. Because the piston rod and fork assembly are coupled by contact engagement only, the fork assembly can be quickly elevated by hand and locked in an upright travel/storage position.

The prior art teaches the moving of hay bales by means of piercing the bales with spikes and then rotating the bales into a preferred attitude for transport. However, the prior art does not teach an advantageous positioning of the spikes so that the bale does not tend to rotate when lifted, and an advantageous supporting surface sized so that the bale is not damaged during transport. The present invention fulfills these needs and provides further related advantages as described in the following summary.

### SUMMARY OF THE INVENTION

The present invention teaches certain benefits in construction and use, which give rise to the objectives described below. It should be noted that prior art methods similar to the present invention tend to damage hay bales by providing insufficient supporting spikes which are misplaced so that the bale rotates after being picked up. Prior art methods also have insufficient supporting surfaces so that the hay bale tends to fall apart when moved over rough terrain.

A method for moving a round hay bale comprises: positioning the bale onto its circular peripheral surface; approaching a proximal flat side of the bale; positioning a main bale impaling spike in a horizontal attitude as supported by a vertical bale support assembly of a tow frame; adjusting a vertical position of the main bale impaling spike at a height above a center of mass of the bale; positioning a pair of lateral bale impaling spikes in parallel with the main bale impaling spike and at a height below the center of mass of the bale; driving the spikes into the bale so as to position the main bale impaling spike above the bale center of mass and to position the pair of lateral bale impaling spikes below and to each side of the bale center of mass; pulling the bale support assembly into a tilted attitude about a rotational axis to lift the bale off the ground; locking the bale support assembly with the bale center of mass positioned to urge the bale support assembly into the vertical; transporting the bale on the tow frame; releasing the bale support assembly to position the bale on the ground; and withdrawing the main and lateral spikes from engagement with the bale.

A primary objective of the present invention is to provide a hay bale moving trailer method having advantages not taught by the prior art.

A further objective is to provide such a method that takes advantage of very simple operation.

A further objective is to provide such a method that moves bales and then unrolls them so that they may be used to feed livestock.

A further objective is to provide a such a method enabled for tipping a bale onto its side.

A further objective is to provide such a method that can handle round bales of different diameters, with different center heights.

A further objective is to provide such a method which can transport bales at a high rate of speed and over rough terrain without the bale being damaged or hay being dislodged from the bale.

A further objective is to provide such a method wherein a hitch tongue is adjusted telescopically so that the apparatus can be used with smaller vehicles.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of the preferred embodiment of the present invention;

FIG. 2 is a side elevational view thereof showing a bale support assembly of the invention in a preferred vertical attitude for piercing a bale;

FIG. 3 is a side elevational view thereof showing the bale support assembly of the invention in a preferred tilted-back attitude for transporting the bale;

FIGS. 4 and 5 are similar to FIG. 2 showing the invention as it approaches and impales a bale;

FIG. 6 is similar to FIG. 3 showing the manner in which a bale is transported;

FIGS. 7 and 8 are elevational views of a spike of the invention showing the manner in which the spike is inserted into a hay bale; and

FIGS. 9 and 10 are elevational views showing the manner in which the invention is used to unroll a hay bale.

### DETAILED DESCRIPTION OF THE INVENTION

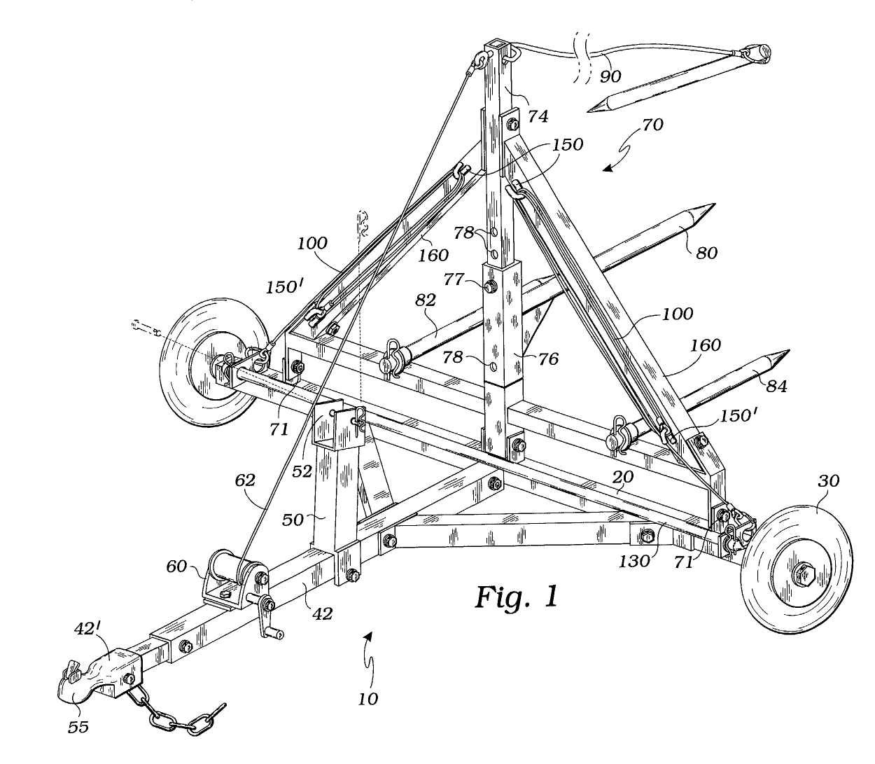

The above described drawing figures illustrate the invention, a bale moving apparatus and method of use comprising a generally horizontal tow frame 10 providing a linear support axle assembly 20 supported by a pair of opposing wheels 30 for moving the tow frame 10 over a terrain surface (not shown). Such a support axle assembly 20 may be taken from the well-known automotive type axle assemblies art. Medially joined with the support axle assembly 20 is a tow bar assembly, providing a tow strut 42 which is preferably of square steel tubing and is welded or bolted to the support axle assembly 20, a medially placed rest bar 50 extending upwardly from the tow strut 42 and of similar construction, a winching means 60, preferably a hand crank, as shown in FIG. 1, or a motor driven winch, and a distal tow fixture 55 such as any such fixture commonly used for towing trailers and such. The described elements of this assembly are joined together using well-known fasteners and techniques.

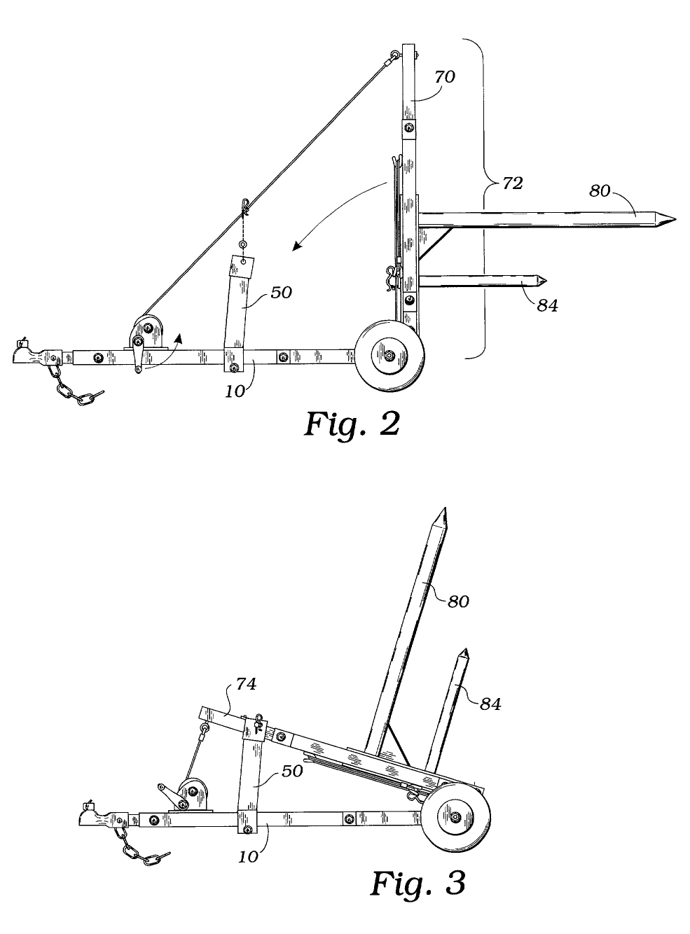

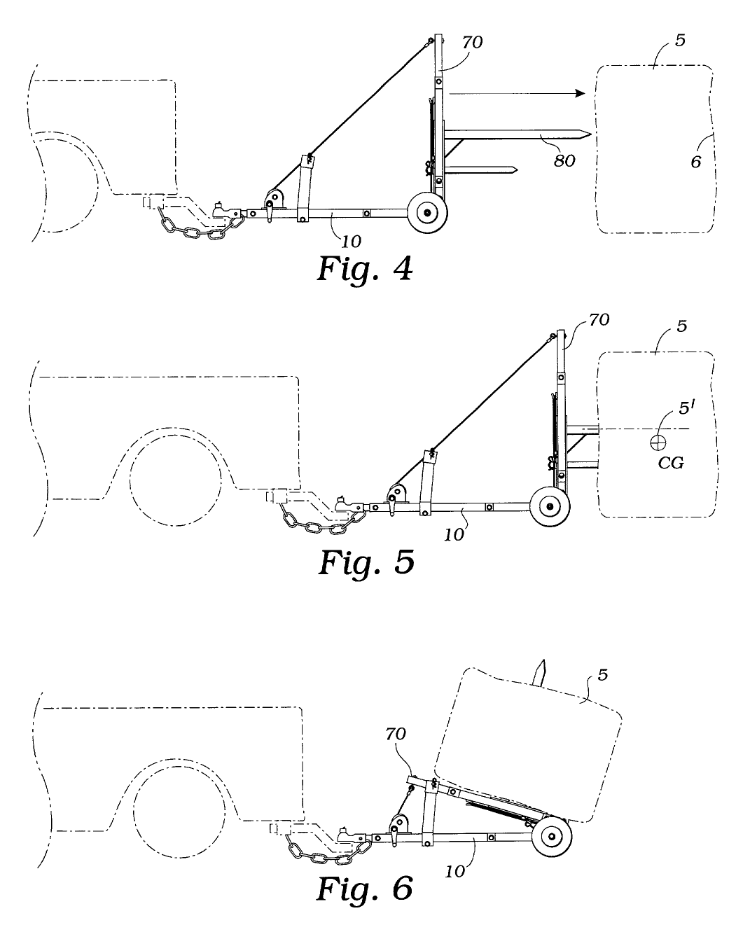

A bale support assembly 70 is pivotally joined to, and extends upwardly from the support axle assembly 20. The bale support assembly 70, including a bale rest surface 72, is tilted back by rotating it about pivot bolts 71, between an upright attitude, as shown in FIG. 2, and a tilted-back attitude, preferably at an angle of between 30 and 45 degrees with respect to the horizontal, as shown in FIG. 3, such that it is able to rest on the rest bar 50. Extending normally from the rest surface 72 is a triangle formation of bale impaling spikes in mutually parallel disposition, such that with the bale support assembly 70 positioned in the upright attitude, a main bale impaling spike 80 is in position for impaling a hay bale 5, preferably above its center of gravity (CG) 5′ (FIG. 5), and two lateral bale impaling spikes 82 and 84 are in position for impaling the hay bale 5 below the spike 80 and the CG 5′, and are in spaced apart lateral positions as shown in FIG. 1.

The winching means 60 is joined with the bale support assembly 70 by a winching cable 62 and is enabled by its tensile strength for pulling the bale support assembly 70 into the tilted-back attitude so as to enable resting the hay bale 5 on the bale rest surface 72 during travel. When the bale 5 has arrived at a desired location, gravity assists in lowering the bale 5 to the ground such that it assumes its original orientation relative to the ground.

Inventively, the rest bar 50 provides a U-shaped receiver 52 for accepting an upright bar 74 of the bale support assembly 70, and further provides a means for locking the upright bar 74 into the U-shaped receiver 52. Preferably, the locking means is a combination dowel pin and cotter pin 54.

Inventively, the apparatus further includes a pull-line 90 which extends to and terminates at a pull-line spike 92 which may be inserted into a bale 5. When the apparatus is pulled forward by the towing vehicle 170, the pull line 90 and the pull line spike 92 are of such size and dimension so as to enable the tipping-over of the bale 5 when the pull line spike 92 is inserted into the distal side 6 of the bale 5.

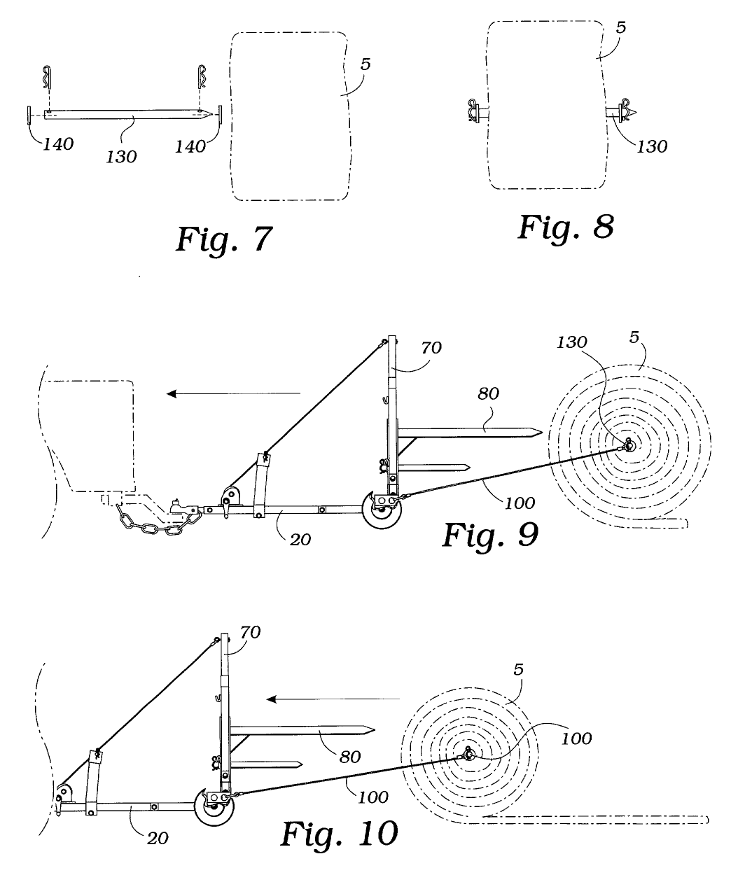

Inventively, the apparatus further provides a means for unrolling a hay bale, as shown in FIGS. 7, 8, 9, and 10. Two cables 100 are attached to the sides of the support axle assembly 20, as shown in FIGS. 9 and 10. At their opposite end, the cables 100 are attached to an unrolling bar 130 by means of tow fixtures (common hardware). The unrolling bar 130 is a spike of such configuration as to be easily pressed through the bale 5 at its center. The unrolling bar 130 is put through the center of the bale 5 parallel with the ground, as shown in FIGS. 7, 8, and 9. When the towing vehicle 170 is driven forward, the cables 100 are pulled taut and they in turn pull the unrolling bar 130 in a forward direction, as indicated by the arrows in FIGS. 9 and 10. The unrolling bar 130 urges and pulls the bale 5 so that it unrolls behind the apparatus. Round washers 140 are placed near the ends of the unrolling bar 130 and held in place with cotter pins, as shown in FIGS. 7 and 8. This prevents the unrolling bar 130 from moving laterally with respect to the bale 5.

Inventively, the apparatus further provides an unrolling means receiving means adapted for storing the unrolling means. When each of the cables 100 are not in use, they are looped around hooks 150 and 150′ attached to support bars 160, such support bars 160 and forming a part of the bale support assembly 70. Each of the support bars 160 preferably forms an angle of approximately 45 degrees with the horizontal.

Inventively, the apparatus further provides a means for vertically positionally adjusting the spike 80 along the upright bar 74 so as to correspond to a range of bale diameters. The vertical positioning of the spike 80 is accomplished by moving sleeve 76, to which the spike 80 is attached, vertically and setting it in a desired vertical position by pinning through aligned holes 77 in the sleeve 76, and in the upright bar 74 (holes 78).

Inventively, the apparatus further comprises a means for linear extension of the tow frame. This is accomplished as shown in FIG. 1, wherein tow strut 42 terminates at hitch 55 in a telescoping portion 42′. Fixing of the telescoping portion 42′ at a selected length is enabled by matching holes in the telescoping portion 42′ with holes in the tow strut 42 in the same manner as with the vertical adjustment of sleeve 76.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for moving a round hay bale comprising: positioning the bale onto a circular peripheral surface thereof; approaching a proximal flat side of the bale; positioning a main bale impaling spike in a horizontal attitude as supported by a vertical bale support assembly of a tow frame; adjusting a vertical position of the main bale impaling spike at a height above a center of mass of the bale; positioning a pair of lateral bale impaling spikes in parallel with the main bale impaling spike and at a height below the center of mass of the bale; driving the spikes into the bale so as to position the main bale impaling spike above the bale center of mass and to position the pair of lateral bale impaling spikes below and to each side of the bale center of mass; pulling the bale support assembly into a tilted attitude about a rotational axis to lift the bale off the ground; locking the bale support assembly with the bale center of mass positioned to urge the bale support assembly into the vertical; transporting the bale on the tow frame; releasing the bale support assembly to position the bale on the ground; and withdrawing the main and lateral spikes from engagement with the bale.

2. The method of claim 1 further comprising: impaling the bale with a pull line spike through a distal flat side of the bale; attaching one end of a pull line to the pull line spike at the distal side of the bale; extending the pull line over the bale; attaching a free end of the pull line to the tow frame; and moving the tow frame away from the bale so as to tip the bale onto the proximal flat side thereof.

3. The method of claim 1 further comprising: approaching the circular surface of the bale; impaling the bale at a center of the bale with an unrolling bar; attaching cables from each opposing end of the unrolling bar to the tow frame; and withdrawing the tow frame from the bale so as to unroll the bale.
